(19) United States
(12) Patent Application Publication
(10) Pub. No.: US 2017/0346202 A1
(43) Pub. Date: Nov. 30, 2017

(54) PRESS FIT TERMINAL

(71) Applicant: SUMITOMO WIRING SYSTEMS, LTD., Yokkaichi (JP)

(72) Inventor: Hideki GOTO, Yokkaichi (JP)

(73) Assignee: SUMITOMO WIRING SYSTEMS, LTD., Yokkaichi (JP)

(21) Appl. No.: 15/605,451

(22) Filed: May 25, 2017

(30) Foreign Application Priority Data
May 30, 2016 (JP) 2016-107850

(51) Int. Cl. H01R 12/58; H01R 13/24

(52) U.S. Cl. CPC H01R 12/585; H01R 13/2457

(57) ABSTRACT

A press fit terminal that includes a terminal metal fitting with a first end and a second end, the terminal metal fitting including: a pressure contact part that is at the first end and that is configured to be press-fit into a through-hole of a printed circuit board and made to be electrically conductive with a conductor at an inner surface of the through-hole, and a connecting part that is at the second end and that is configured to be connected to a mating member.

### BACKGROUND

This disclosure relates to a press fit terminal that is made electrically conductive with a conductor that is provided inside of a through-hole of a printed circuit board by being press-fit to the through-hole.

Conventionally, a connection terminal is used to electrically connect (i) a circuit conductor arranged on a substrate such as a printed circuit board or the like and (ii) a mating member such as a connector or the like. As such a connection terminal, a so-called press fit terminal is known, which is disclosed in, for example, Japanese Published Patent Application 2004-127610. Such a press fit terminal is provided with (i) a pressure contact part having a spring property on one end of a terminal metal fitting and (ii) a connecting part that is connected to a mating member on the other end of the terminal metal fitting. By press-fitting and fixing the pressure contact part into a through-hole of a substrate, the press fit terminal can be made conductive with a conductor provided in the through-hole and fixed to the substrate without soldering.

As disclosed in Japanese Published Patent Application 2004-127610, the press fit terminal is formed by press-punching a metal plate. Furthermore, at one end of the terminal metal fitting, a pair of arch-shaped pressure contact parts is formed by punching a through-hole at the center portion, and a spring property is given as the pair of pressure contact parts is elastically deformed in a plate width direction.

However, a thickness dimension in the plate width direction is much larger than that in a plate thickness direction, so it was difficult to obtain a sufficient flexure amount. Thus, a force by which the pair of pressure contact parts is inserted through the through-hole unavoidably becomes large, and there was a possibility that metal waste might be generated by having the pressure contact parts scrape the inner surface of the through-hole. Additionally, a force by which the pair of pressure contact parts is inserted through through-hole becomes large, so the terminal may roll such that the pressure contact parts are arranged at a region in which a diameter dimension is made large due to irregularity of manufacturing the through-hole or the like. Thus, there was a possibility that more metal waste may be generated by having the pressure contacts parts scrape a wider range of the inner surface of the through-hole.

Therefore, first, as shown in FIG. 15 of Japanese Published Patent Application 2016-27536, this inventor proposed a press fit terminal in which a pressure contact part is formed by providing a slit that extends in a length direction at a center portion of the terminal and causing both sides of the slit to protrude in mutually opposite directions. According to this press fit terminal, a spring property is given since the pressure contact part can be elastically deformed in a plate thickness direction. Because of this, compared to a conventional case in which a pressure contact part can be elastically deformed in the direction of a plate width that is much more than a thickness dimension in a plate thickness direction, an insertion force of the pressure contact part with respect to the through-hole can be reduced, and the problem of the pressure contact parts scraping an inner surface of the through-hole can also be alleviated. Accordingly, the pressure contact part having a sufficient spring property (flexure amount) can be advantageously formed, so the pressure contact parts can be reliably pressed into contact with the through-hole.

### SUMMARY

However, when the press fit terminal is inserted through the through-hole, a direction of pressure applied to each pair of pressure contact parts faces a center of the through-hole, but each pair of the pressure contact parts can only be elastically deformed in a plate thickness direction. Thus, there was a possibility that a component of force in a rotational direction is generated, and that rolling might be generated. Because of this, there is still room for improvement, and development of more improved press fit terminals has been proceeding.

An exemplary aspect of the present disclosure provides a press fit terminal having a new structure, in which a flexure amount of a pressure contact part is ensured, an insertion force of the pressure contact part with respect to a through-hole is reduced, and generation of rolling of the pressure contact part in the through-hole is suppressed.

According to an exemplary aspect of the present disclosure, a press fit terminal includes a terminal metal fitting with a first end and a second end, the terminal metal fitting including: a pressure contact part that is at the first end and that is configured to be press-fit into a through-hole of a printed circuit board and made to be electrically conductive with a conductor at an inner surface of the through-hole, and a connecting part that is at the second end and that is configured to be connected to a mating member, wherein: the first end of the terminal metal fitting is provided with: a through-hole that cuts out a center portion of the terminal metal fitting in a plate thickness direction, and a pair of elastic pressure contact pieces that are separated from each other at both sides in a plate width direction via the through-hole, center portions of the elastic pressure contact pieces in a length direction being deformed so as to respectively protrude to both sides of the terminal metal fitting in the plate thickness direction, and the pressure contact part being formed by the center portions in the length direction.

According to this exemplary aspect, there is formed a pair of elastic pressure contact pieces that are separated from each other on both sides of a through-opening that cuts out a center portion of a pressure contact lead part, and the pressure contact part is formed such that the center portions of the elastic pressure contact pieces in the length direction are deformed so as to protrude in mutually opposite directions in the plate thickness direction of the terminal metal fitting. Because of this, the pair of pressure contact pieces can be elastically deformed in the plate thickness direction. Compared to a conventional case in which pressure contact parts can be elastically deformed in the plate width direction, an insertion force of the pressure contact part with respect to the through-hole can be reduced, and the problem of the pressure contact part scraping an inner surface of the through-hole can also be alleviated. Additionally, a pressure contact part having a sufficient spring property (flexure amount) can be advantageously formed, so the pressure contact part can be reliably brought into pressure contact with the through-hole.

Furthermore, by providing the through-opening, the pair of elastic pressure contact pieces can be elastically deformed in the plate thickness direction as well as being deformed toward the inside of the through-opening, that is, toward a center axis of the through-hole. Thus, compared to a conventional case in which a pair of elastic pressure contact pieces is elastically deformed in a plate thickness direction only, pressure that is applied to the pressure contact part toward the center axis of the through-hole can be advantageously absorbed by elastic deformation of the pair of elastic pressure contact pieces. Thus, the possibility of an extra component of force in a rotational direction or the like being generated, and of rolling or the like occurring, can be reduced. In addition, an insertion force of the pressure contact part with respect to the through-hole can also be further reduced, so the problem of the pressure contact part scraping an inner surface of the through-hole can also be alleviated.

According to an exemplary aspect of the disclosure, base ends of the elastic pressure contact pieces, which respectively become connecting portions to a center portion of the terminal metal fitting in the length direction, are separated from each other in the plate width direction by the through-opening.

According to this exemplary aspect, the base ends of the pair of elastic pressure contact pieces are arranged so as to be separated from each other via the through-opening in the plate width direction. Thus, a sufficient interval can be ensured between the elastic pressure contact pieces. Thus, when pressure is applied to the pressure contact part, the elastic pressure contact pieces can be more easily deformed to the inside of the through-opening. Because of this, compared to a conventional case in which elastic pressure contact pieces are elastically deformed in a plate thickness direction only, the possibility of an extra component of force in a rotational direction or the like being generated, and of rolling or the like occurring, can be more reliably suppressed.

According to an exemplary aspect of the disclosure, at outer circumferential surfaces of the pair of elastic pressure contact pieces, at a position closer to the first end of the terminal metal fitting than the pressure contact part, abutment protruding parts are arranged, and in a state in which the press fit terminal is mounted to the printed circuit board, the abutment protruding parts contact a surface of the printed circuit board.

According to this exemplary aspect, the abutment protruding parts contact the surface of the printed circuit board. Thus, even if excessive insertion force is applied to the press fit terminals, such excessive insertion force can be dispersed to the printed circuit board side. Thus, the press fit terminals can be stably and erectly held on the printed circuit board.

According to this disclosure, a pair of elastic pressure contact pieces that are separated from each other on both sides of a through-opening that cuts out a center portion of a pressure contact lead part, and a pressure contact part is formed such that the center portions of the elastic pressure contact pieces in the length direction are deformed so as to protrude in mutually opposite directions in the plate thickness direction. Because of this, compared to a conventional case in which a pressure contact part can be elastically deformed in the plate width direction, an insertion force of the pressure contact part with respect to the through-hole can be reduced, and the problem of the pressure contact part scraping an inner surface of the through-hole can also be alleviated. Furthermore, because a pressure contact part having a sufficient spring property (flexure amount) can be advantageously formed, so the pressure contact part can be reliably brought into pressure contact with the through-hole. Additionally, by having the through-opening, the pair of elastic pressure contact pieces can be elastically deformed toward the inside of the through-opening as well as in the plate thickness direction, that is, can be elastically deformed toward the center axis of the through-hole. Thus, compared to a conventional case in which a pair of elastic pressure contact pieces is elastically deformed in a plate thickness direction only, pressure that is applied to the pressure contact part toward the center axis of the through-hole can be advantageously absorbed by elastic deformation of the pair of elastic pressure contact pieces. Thus, the possibility of an extra component of force in a rotational direction or the like being generated, and of rolling or the like occurring, can be reduced. In addition, an insertion force of the pressure contact part with respect to the through-hole can be also further reduced, so the problem of the pressure contact part scraping an inner surface of the through-hole can also be further reduced.

### BRIEF DESCRIPTION OF THE DRAWINGS

Various exemplary aspects of the disclosure will be described with reference to the drawings, wherein:

FIG. 1 is a perspective view showing a press fit terminal of a first exemplary aspect of this disclosure.

FIG. 2 is a front view of FIG. 1.

FIG. 3 is a right side view of FIG. 1.

FIG. 4 is a perspective view showing a state in which press fit terminals of this exemplary aspect are arranged to stand on a printed circuit board.

FIG. 5 is a front view of FIG. 4.

FIG. 6 is a right side view of FIG. 4.

FIG. 7 is a perspective view showing a press fit terminal of a second exemplary aspect of this disclosure.

### DETAILED DESCRIPTION OF EMBODIMENTS

Hereafter, exemplary aspects of this disclosure will be explained with reference to the drawings.

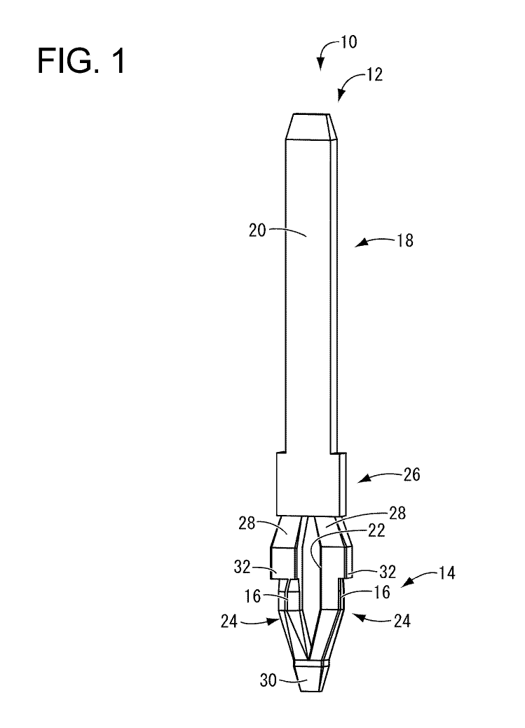

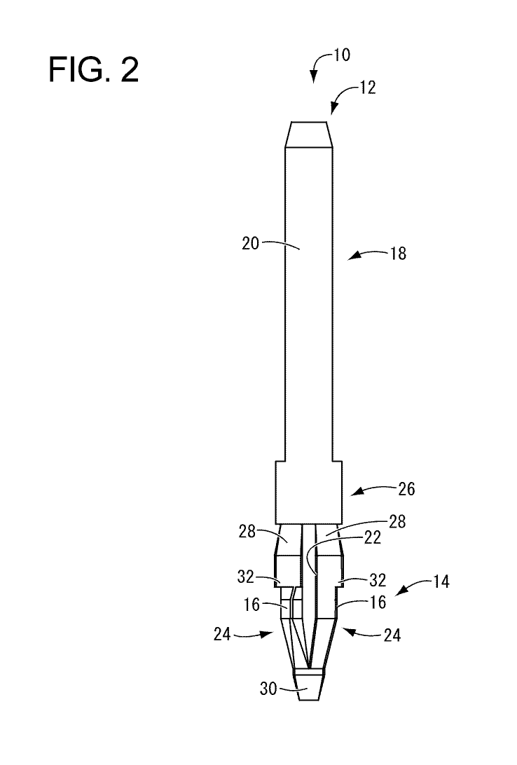

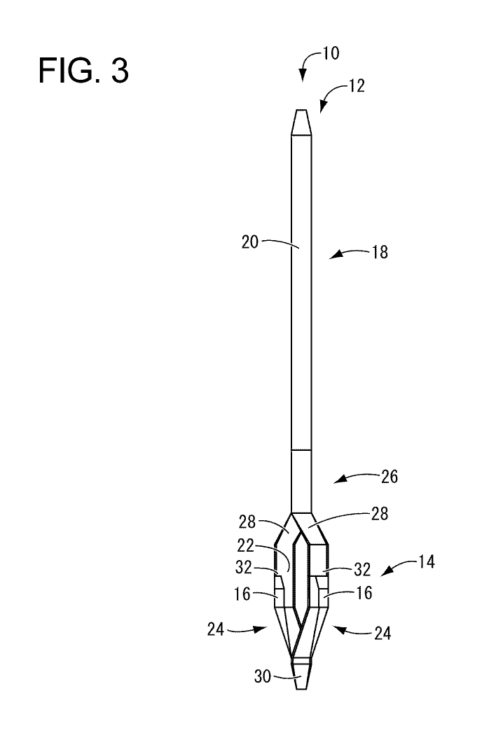

First, FIGS. 1-3 show a press fit terminal 10 of a first exemplary aspect of this disclosure. The press fit terminal 10 is an integrally formed article in which (i) pressure contact parts 16 are provided at one end 14 (lower end of FIGS. 1-3) of a terminal metal fitting 12 and (ii) a connecting part 20 that is connected to an undepicted mating member is formed at another end 18 (upper end of FIGS. 1-3) of the terminal metal fitting 12. Additionally, in the following description, “upper” refers to an upper part of FIGS. 1-3, “lower” refers to a lower part of FIGS. 1-3, “front” refers to a left part of FIG. 3, and “rear” refers to a right part of FIG. 3. Furthermore, a plate thickness direction refers to right/left directions of FIG. 3, a plate width direction refers to right/left directions of FIG. 2, and a length direction refers to up/down directions of FIGS. 1-3.

The terminal metal fitting 12 has a flat plate shape and is formed such that a metal plate is press-punched, which has been plated by, for example, tin or the like on a surface of a copper plate or the like. The pressure contact parts 16 are arranged at the one end 14 of the thus-constituted terminal metal fitting 12. More specifically, at the one end 14 of the terminal metal fitting 12, there are (i) a through-opening 22 that has a substantially longitudinally rectangular shape in a front view and extends in the length direction (up/down directions of FIG. 2) of the terminal metal fitting 12 by cutting out a center portion in the plate width direction (right/left directions of FIG. 2) of the terminal metal fitting 12 and (ii) a pair of elastic pressure contact pieces 24, 24, each of which has a substantially rectangular shape in a front view, and which are separated at both sides in the plate width direction by the through-opening 22, and extend in the length direction. The pair of elastic pressure contact pieces 24, 24 is constituted such that respective base ends 28, which become connecting portions to a center portion 26 to a center portion of the terminal metal fitting 12 in the length direction that is slightly wider than the one end 14 of the terminal metal fitting 12, are separated from each other in the plate width direction via the through-opening 22, and respective tip ends 30 are connected to each other. Additionally, these tip ends 30 have a tapered shape. Additionally, the center portion of the pair of thus-constituted elastic pressure contact pieces 24, 24 in the length direction is deformed so as to protrude to both sides (both right and left sides of FIG. 3) of the terminal metal fitting 12 in the plate thickness direction, whereby pressure contact parts 16 are formed at the center portion in the length direction. In addition, at outer circumferential surfaces of the pair of elastic pressure contact pieces 24, 24, at a position closer to the one end 14 of the terminal metal fitting 12 than the pressure contact parts 16, abutment protruding parts 32 are formed by the outer circumferential surfaces facing outwardly and protruding at a substantially constant dimension.

Meanwhile, at the other end 18 of the terminal metal fitting 12, the connecting part 20 is arranged, which extends in a substantially rectangular shape in the length direction of the terminal metal fitting 12 (up/down directions of FIG. 2). In the same manner as the tip ends 30 of the pair of elastic pressure contact pieces 24, 24, a tip end of the connecting part 20 (upper end part of FIG. 2) also has a tapered shape.

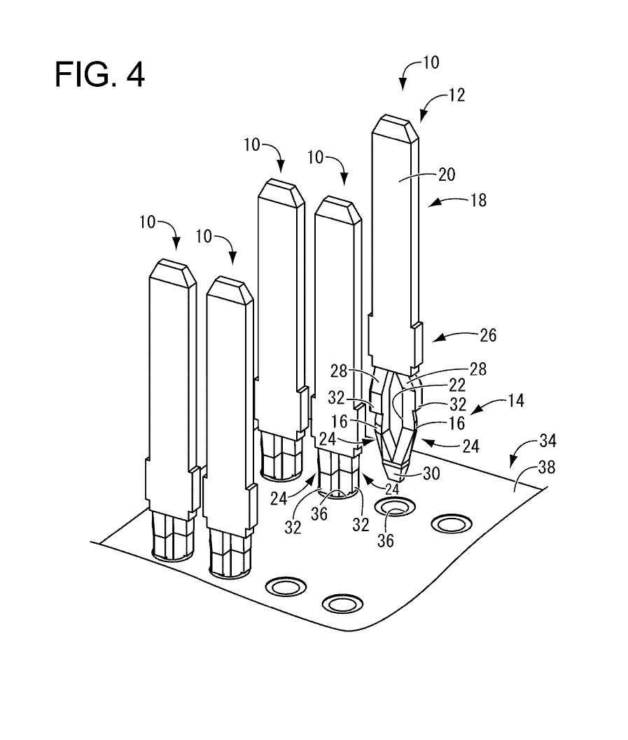

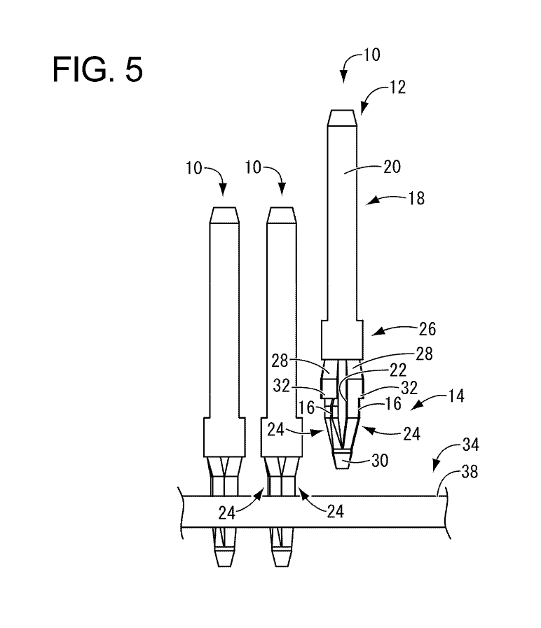

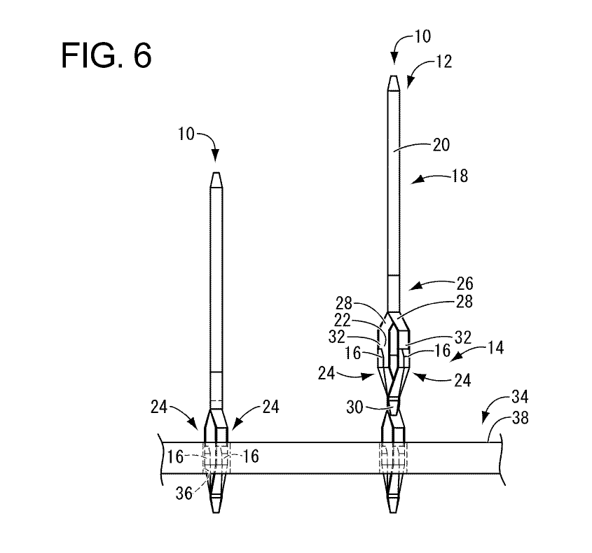

As shown in FIGS. 4-6, press fit terminals 10 constituted as described above are inserted through through-holes 36 of a printed circuit board 34, from the pairs of elastic pressure contact pieces 24, 24 arranged at the one ends 14 of the terminal metal fittings 12. The tip ends 30 of the pairs of elastic pressure contact pieces 24, 24 have a tapered shape, so the tip ends 30 become guides, and an operation of inserting the press fit terminals 10 through the through-holes 36 can be stably and efficiently performed. When the press fit terminals 10 are pushed further into the through-holes 36, the center portions of the pairs of elastic pressure contact pieces 24, 24 in the length direction are elastically deformed inward in the plate thickness direction (right/left directions of FIG. 6) and inward in the plate width direction (right/left directions of FIG. 5). Thus, the pairs of elastic pressure contact pieces 24, 24 can be inserted through the through-holes 36. Then, as shown in FIG. 6, after the pairs of elastic pressure contact pieces 24, 24 are inserted through the through-holes 36, the pressure contact parts 16 that are constituted at the center portions of the pairs of elastic pressure contact pieces 24, 24 of the press fit terminals 10 in the length direction are pressed into contact with the insides of the through-holes 36 due to elastic recovery force based on elastic deformation when the pair of elastic pressure contact pieces 24, 24 are inserted through the through-holes 36. That is, the pairs of elastic pressure contact pieces 24, 24 of the press fit terminals 10 are press-fittingly fixed with respect to the through-holes 36. Thus, the press fit terminals 10 are made to be electrically conductive with undepicted conductors arranged at inner surfaces of the through-holes 36 via the pressure contact parts 16 arranged on the pairs of elastic pressure contact pieces 24, 24. Furthermore, these conductors are connected to printed wiring formed on the printed circuit board 34. Additionally, to facilitate understanding, FIG. 6 shows a state in which the inner surfaces of the through-holes 36 are slightly separated from the pressure contact parts 16.

In addition, as shown in FIG. 4, in a state in which the pairs of elastic pressure contact pieces 24, 24 have been inserted through the through-holes 36 and mounted to the printed circuit board 34, the abutment protruding parts 32 arranged at the outer circumferential surfaces of the base ends 28 of the pairs of the elastic pressure contact pieces 24, 24 contact a surface 38 of the printed circuit board 34. That is, the amount by which the press fit terminals 10 are inserted through the through-holes 36 is defined by having the abutment protruding parts 32 contact the surface 38 of the printed circuit board 34.

According to the thus-constituted press fit terminals 10, the pairs of elastic pressure contact pieces 24, 24, including, at their center portions in the length direction, the pressure contact parts 16 that are press-fit into the through-holes 36 of the printed circuit board 34 and made to be electrically conductive with undepicted conductors arranged at inner surfaces of the through-holes 36, are deformed so as to respectively protrude to both sides (both right and left sides of FIG. 3) of the terminal metal fitting 12 in the plate thickness direction. Thus, the pairs of pressure contact parts 16, 16 can be elastically deformed in the plate thickness direction. Because of this, compared to a conventional case in which a pairs of pressure contact parts can be elastically deformed in a plate width direction, the insertion force of the pressure contact parts 16 with respect to the through-holes 36 can be reduced, so a problem of the pressure contact parts 16 scraping inner surfaces of the through-holes 16 can be advantageously alleviated. At the same time, a sufficient flexure amount (spring property) can be ensured, so the pressure contact parts 16 can be reliably pressed into contact with the inner surfaces of the through-holes 36.

Furthermore, the elastic pressure contact pieces 24, 24 are separated from each other via the through-opening 22 in the plate width direction and can be thus elastically deformed in the plate width direction as well as the plate thickness direction. Because of this, compared to a conventional case in which a pair of elastic pressure contact pieces can be elastically deformed in only one of a plate width direction or a plate thickness direction, pressure that is applied to the pressure contact parts 16 facing the inside of the through-hole 36 can be advantageously absorbed by elastic deformation of the pair of elastic pressure contact pieces 24, 24 in the plate thickness direction and the plate width direction. Thus, the possibility of the problem of an extra component of force being generated in a rotational direction or the like by such pressure, and the press fit terminal 10 rolling and the like, can be reduced. Additionally, an insertion force of the pressure contact parts 16 with respect to the through-holes 36 can be further reduced, and the problem of the pressure contact parts 16 scraping an inner surface of the through-hole 36 can also be alleviated.

In addition, in a state in which the press fit terminals 10 are mounted to the printed circuit board 34, the abutment protruding parts 32 arranged on the pairs of elastic pressure contact pieces 24, 24 contact the surface 38 of the printed circuit board 34. Thus, even if excessive insertion force is applied to the press fit terminals 10, such excessive insertion force can be dispersed to the printed circuit board 34 side. Thus, the press fit terminals 10 can be stably and erectly held on the printed circuit board 34.

Above, exemplary aspects of this disclosure were explained in detail, but this disclosure is not limited to these specific descriptions. For example, in the above-mentioned exemplary aspects, the center portions of the pair of elastic pressure contact pieces 24, 24 in the length direction are deformed so as to respectively protrude to both sides (both right and left sides of FIG. 3) of the terminal metal fitting 12 in the plate thickness direction and are formed so as not to overlap each other in a side view (see FIG. 3), but they do not need to be formed so as not to overlap each other in a side view.

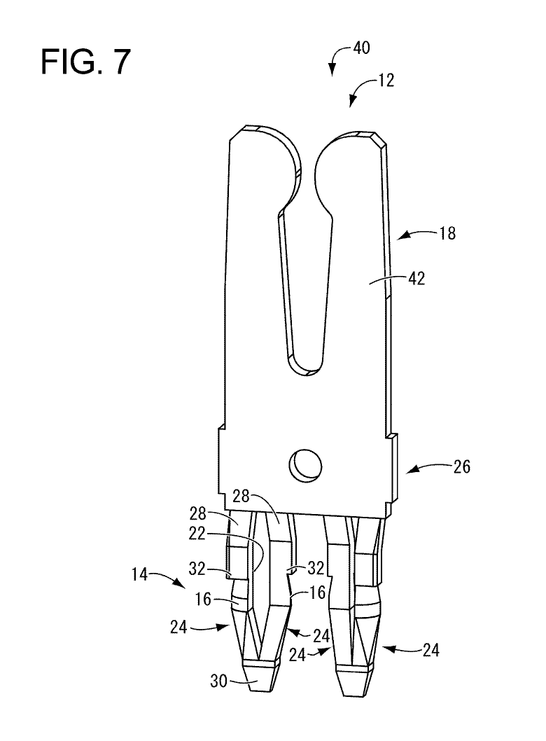

Additionally, for example, in the above-mentioned first exemplary aspect, only one pair of elastic pressure contact pieces 24, 24 is arranged at the one end 14 of the terminal metal fitting 12, and the connecting part 20 which is formed at the other end 18 of the terminal metal fitting 12 has a simple rectangular shape. However, for example, as in a press fit terminal 40 of a second exemplary aspect shown in FIG. 7, two pairs of elastic pressure contact pieces 24 can be arranged at the one end 14 of the terminal metal fitting 12, and a connecting part 42 formed at the other end 18 of the terminal metal fitting 12 can have a tuning fork shape. Thus, compared to the above-mentioned first exemplary aspect, the press fit terminal 40 can be connected to the printed circuit board 34 with lower resistance and can be reliably erectly arranged, so it can be connected to more types of mating members. In short, the number of elastic pressure contact pieces 24 and the shape of the connecting part can be arbitrarily selected.

What is claimed is:

1. A press fit terminal comprising:
a terminal metal fitting with a first end and a second end, the terminal metal fitting including:
a pressure contact part that is at the first end and that is configured to be press-fit into a through-hole of a printed circuit board and made to be electrically conductive with a conductor at an inner surface of the through-hole, and
a connecting part that is at the second end and that is configured to be connected to a mating member, wherein:
the first end of the terminal metal fitting is provided with:
a through-hole that cuts out a center portion of the terminal metal fitting in a plate thickness direction, and
a pair of elastic pressure contact pieces that are separated from each other at both sides in a plate width direction via the through-hole, center portions of the elastic pressure contact pieces in a length direction being deformed so as to respectively protrude to both sides of the terminal metal fitting in the plate thickness direction, and the pressure contact part being formed by the center portions in the length direction.

2. The press fit terminal as set forth in claim 1, wherein:
base ends of the elastic pressure contact pieces, which respectively become connecting portions to a center portion of the terminal metal fitting in the length direction, are separated from each other in the plate width direction by the through-opening.

3. The press fit terminal as set forth in claim 1, wherein:
at outer circumferential surfaces of the elastic pressure contact pieces, at a position closer to the first end of the terminal metal fitting than the pressure contact part, abutment protruding parts are arranged, and
in a state in which the press fit terminal is mounted to the printed circuit board, the abutment protruding parts contact a surface of the printed circuit board.

4. The press fit terminal as set forth in claim 2, wherein:
at outer circumferential surfaces of the elastic pressure contact pieces, at a position closer to the first end of the terminal metal fitting than the pressure contact part, abutment protruding parts are arranged, and
in a state in which the press fit terminal is mounted to the printed circuit board, the abutment protruding parts contact a surface of the printed circuit board.
